(19) United States
(12) Patent Application Publication
(10) Pub. No.: US 2011/0104551 A1
(43) Pub. Date: May 5, 2011

(54) NANOTUBE COMPOSITE ANODE MATERIALS SUITABLE FOR LITHIUM ION BATTERY APPLICATIONS

(75) Inventors: Junbing YANG, Bolingbrook, IL (US); Wenquan LU, Naperville, IL (US)

(73) Assignee: UCHICAGO ARGONNE, LLC, Chicago, IL (US)

(21) Appl. No.: 12/938,638

(22) Filed: Nov. 3, 2010

Related U.S. Application Data
(60) Provisional application No. 61/280,627, filed on Nov. 5, 2009.

(51) Int. Cl. H01M 4/485; H01M 10/26; H01M 4/58; H01M 4/56; H01M 4/60; H01M 4/525; H01M 4/54; H01M 4/583; H01M 6/42; B82Y 30/00

(52) U.S. Cl. 429/149; 429/207; 429/231.95; 429/226; 429/229; 429/222; 429/231.6; 429/212; 429/223; 429/219; 429/220; 429/221; 429/231.5; 429/231.8; 977/742; 977/750; 977/752

(57) ABSTRACT

The present invention provides a composite material suitable for use in an anode for a lithium ion battery, the composite material comprising a layer of a lithium-alloying material on the walls of an aligned nanotubular base material. Preferably, the lithium-alloying material comprises a material selected from the group consisting of Si, Sn, Pb, Al, Au, Pt, Zn, Cd, Ag, Mg, and a combination of two or more of the foregoing.

### CROSS-REFERENCE TO RELATED APPLICATIONS

This application claims the benefit of U.S. Provisional Application Ser. No. 61/280,627, filed on Nov. 5, 2009, which is incorporated herein by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to anode materials for lithium ion batteries. More particularly, the invention relates to nanotube composite materials suitable for use as anode materials in lithium ion batteries.

### BACKGROUND OF THE INVENTION

The use of Li-ion batteries as rechargeable power sources represents a promising technology for use in the development of consumer electronics and electric-based vehicles. Lithium ion batteries (LIBs) with high energy density are in increasing demand. Since Sony commercialized lightweight LIBs for electronics in 1991, these batteries have been used widely in laptops, mobile phones, and other devices. However, there are substantial technical challenges to use this battery for automobile applications. The existing LIB technology uses LiCoO₂ as the cathode material, graphite as the anode material, and a lithium salt such as LiPF₆ in an organic solvent (e.g., organic carbonates) as the electrolyte. Since its commercialization, LIB capacity has increased about 1.7 times due to improvements in battery structure and enhancement in the capacity of the anode/cathode/electrolyte materials. In terms of battery manufacturing technology, the battery capacity typically has been increased by increasing the amount of the active materials in the cathode, anode and electrolyte, and by decreasing the thickness of the current collector, separator, and cell case. These efforts appear to have approached their limits in terms of improving battery capacity. Current LIB capacity also has been improved by utilizing new cathode materials, such as layered Li[NiₓCO_{y}Mn_{z}]O₂, Li—Mn—O spinels, LiFePO₄ (olivine), and related materials. Use of such new materials has provided about 9 to about 18% increase in total mAh/g capacity over today's commercial cells, which is still insufficient to satisfy the requirements of plug-in hybrid electric vehicles (PHEVs).

Current anode materials for LIBs typically fall into one of two types of materials: intercalation materials and alloy-forming materials. Graphite is a material based on intercalating lithium ion into its carbon layers for storage of lithium. Graphite exhibits good charge/discharge cycle stability, but low capacity (theoretical capacity is 372 mAh/g based on a theoretical Li-to-C ratio (Li:C) of about 1:6 (i.e., LiC₆). Other materials, including Si, Sn, Pb, Al, Au, Pt, Zn, Cd, Ag, and Mg, can be used as an alternative to graphite. These materials store lithium via formation of a lithium alloy. Among known lithium-alloying materials, silicon is one of the most attractive, since it has a relatively low discharge potential, the highest known theoretical capacity (about 4200 mAh/g based on Li_{4,4}Si), and a large natural availability reserve (silicon is the second most abundant element on earth). A disadvantage of alloy-forming materials such as silicon is that capacity typically fades quickly due to a very large volume expansion upon alloy formation, which can result in disruption (e.g., pulverization) of the electrode and loss of electric contact between electrode materials. For example, silicon undergoes up to 400% volume change during the alloying and de-alloying process. Silicon also possesses a relatively low electrical conductivity, which has a negative effect on the power capacity of the battery.

In view of the foregoing, there is an ongoing need for new, relatively high specific capacity anode materials.

### SUMMARY OF THE INVENTION

The present invention provides a composite material suitable for use in an anode for a lithium ion battery. The composite material comprises a layer of lithium-alloying material on the walls of an aligned nanotubular base material.

The lithium-alloying material preferably is selected from the group consisting of Si, Sn, Pb, Al, Au, Pt, Zn, Cd, Ag, Mg, and a combination of two or more of the foregoing. Silicon is particularly preferred.

The aligned nanotubular base material preferably comprises a material selected from the group consisting of a conductive organic polymer, a conductive or semiconductive inorganic material, or a combination thereof. In some preferred embodiments the aligned nanotubular base material comprises at lease one material selected from the group consisting of polyaniline, polypyrrole, and polythiophene. In other preferred embodiments the aligned nanotubular base material comprises at least one material selected from the group consisting of a metal (e.g., Ni, Ag, Cu, Te, Co, Fe, Bi), a chalcogenide (e.g., MoS₂, WS₂, MoSe₂, WSe₂, NbS₂, NbSe₂, HfS₂, ZrS₂, TiS₂, TiS₂, TiSe₂), an oxide (e.g., TiO₂, H₂Ti₃O₇, ZrO₂, VOₓ, SiO₂, IrO₂, ZnO, Ga₂O₃, BaTiO₃, PbTiO₃, K₄Nb₆O₁₇), a nitride (e.g., BN, AIN, GaN), a phosphide (e.g., InP), a halide (e.g. NiCl₂), and carbon. In a preferred embodiment, the aligned nanotubular base material comprises aligned carbon nanotubes (ACNT). The aligned nanotubular base material can include single-walled carbon nanotube, multi-walled carbon nanotubes, or both; and can be open-ended nanotubes, close-ended nanotubes, or both.

Preferably, the aligned nanotubular base material comprises nanotubes having diameters of not more than about 100 nm, e.g., diameters in the range of about 2 to about 100 nm. The aligned nanotubular base material preferably comprises nanotubes having an average spacing between any two adjacent nanotubes in the range of about 5 to about 300 nm.

In some embodiments, the lithium-alloying material is present on the surface of the aligned nanotubular base material in a layer having an average thickness in the range of about 1 to about 200 nm. The layer of lithium-alloying material on the surface of the aligned nanotubular base material can be comprises a film or can comprise particles of the lithium-alloying material, or both. The lithium-alloying material can be coated on the exterior tubular surfaces of the aligned nanotubular base material, the interior tubular surfaces of the aligned nanotubular base material, or both.

In another aspect, the present invention provides an electrochemical cell comprising a cathode, an anode and a lithium ion-containing electrolyte therebetween, wherein the anode comprises the composite material of the present invention. In some embodiments cathode comprises one or more of a lithium metal oxide, a phosphate, a spinel, and the like. Preferably, the lithium ion-containing electrolyte comprises a lithium salt in an organic solvent (e.g., an organic carbonate solvent).

In yet another aspect, the present invention provides a battery comprising a plurality of the electrochemical cells of the invention arranged in series, parallel, or both.

### BRIEF DESCRIPTION OF THE DRAWINGS

FIG. 1 shows an exemplary structure and mechanism for the use of a Si-ACNT composite as an anode material for Li-ion battery.

FIG. 2 schematically illustrates a nanotube including thin films of a lithium-alloying material on the interior and exterior of the nanotube.

FIG. 3 illustrates a similar nanotube to the one shown in FIG. 2 except that the lithium-alloying material is present in the form of particles rather than thin films.

FIG. 4 provides scanning electron microscope (SEM) images of aligned carbon nanotubes (ACNT) along the nanotube alignment axis (Panel A), and in a side-view (Panel B).

FIG. 5 provides SEM image of aligned conducting polymer nanotubes along the nanotube alignment axis (Panel A), and a side-view transmission electron microscope (TEM) image of conducting polymer nanotube (Panel B).

FIG. 6 provides a SEM image of silicon-coated ACNTs of the invention.

FIG. 7 provides electrochemical cycling data for the Si-ACNT material shown in FIG. 6; Panel A provides a plot of Votage versus Capacity; Panel B provides a plot of Capacity versus cycle number.

FIG. 8 shows a plot of stability versus cycling number of a silicon-aligned carbon nanotube (ACNT) composite material of the present invention.

### DETAILED DESCRIPTION OF THE PRESENT INVENTION

The present invention relates to improved anode materials for a Li-ion battery that provide increased dimensional stability during lithiation and delithiation. The anode materials of the present invention afford a significant increase in specific capacity together with significant improvements in long term stability.

The new materials of the invention comprise a composite structure of a lithium-alloying material coated on the wall surfaces of an aligned nanotubular base material. The lithium-alloying material preferably is selected from Si, Sn, Pb, Al, Au, Pt, Zn, Cd, Ag, Mg, and a combination of two or more of the foregoing. Silicon is a preferred lithium-alloying material. The silicon can comprise crystalline silicon, amorphous silicon, silicon compounds such as silicon carbide and silicon oxide, or any combination of two or more of the foregoing.

The lithium-alloying material (e.g., Si) is present on at least a portion of the wall surfaces of the nanotubes as a relatively thin layer which can be a film, a particulate layer, or a combination thereof. The layer of lithium-alloying material can be present on the exterior wall-surfaces of the nanotubes, and in the case of open-ended nanotubes, the lithium-alloying material can be present on the interior wall surfaces, as well. The layer of lithium-alloying material (e.g., Si) can have a thickness in the range of about 1 to about 200 nm, more preferably about 10 to about 100 nm.

Preferably, the aligned nanotubular base material comprises nanotubes with a diameter not more than about 100 nm. The nanotubes preferably have a diameter in the range of about 2 to about 100 nanometers, and a pitch (spacing) between any two adjacent carbon nanotubes in the range of about 5 to about 300 nanometers. The nanotubes can comprise open ended nanotubes, sealed nanotubes, or both. Preferably, the nanotubes comprise predominately open-ended nanotubes. The nanotubes can comprise organic materials, inorganic materials, or a combination thereof. The nanotube material can comprise single-walled nanotubes, multi-walled nanotubes, or a combination thereof.

In one embodiment, the nanotubes comprise a conductive polymer such as polyaniline, polypyrrole or polythiophene. In other embodiments of the present invention the nanotubes comprise various inorganic conductive or semiconductive materials such as metals (e.g., Ni, Ag, Cu, Te, Co, Fe, Bi), chalcogenides (e.g., MoS₂, WS₂, MoSe₂, WSe₂, NbS₂, NbSe₂, HfS₂, ZrS₂, TiS₂, TiS₂, TiSe₂), oxides (e.g., TiO₂, H₂Ti₃O₇, ZrO₂, VOₓ, SiO₂, IrO₂, ZnO, Ga₂O₃, BaTiO₃, PbTiO₃, K₄Nb₆O₁₇), nitrides (e.g., BN, AIN, GaN), phosphides (e.g., InP), halides (e.g. NiCl₂), carbon, and any combination of such materials. Carbon nanotubes are particularly preferred. The aligned nanotubular base material serves as support material for the lithium-alloying material, and provides dimensional stability for the lithium alloy formed during the lithiation and delithiation process, as well as establishing an electronic conducting pathway within the electrode.

As used herein the term “carbon nanotubes” and grammatical variations thereof refers to nanotubular materials that comprise predominately carbon, and can optionally include lesser amounts of other materials such as nitrogen and metals (e.g., Fe). Methods of preparing such aligned carbon nanotubes are well known in the art. The term “aligned” when used in reference to nanotube materials means that the nanotubes are substantially parallel to one another and are substantially perpendicular to a substrate material on which they are formed or coated (e.g., a conductive metal foil).

In some embodiments, the stability of the lithium-alloying material—nanotube composite of the invention is improved by modification of the nanotube wall surfaces to facilitate formation of chemical bonds between the lithium-alloying material and the nanotube walls, leading to improved structural stability. Non-limiting examples of surface modifications of nanotubes (e.g., ACNT) include incorporation of oxygen, nitrogen, sulfur, and/or metal containing functional groups on the wall surfaces.

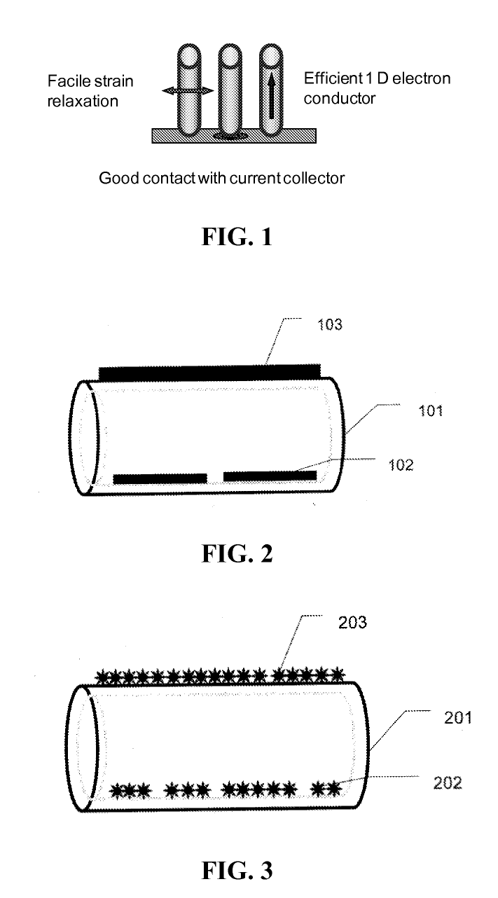

A schematic of a Si-ACNT composite anode configuration is shown in FIG. 1. The ACNTs are grown directly on the metallic current collector substrate. The Si-ACNT materials provide a synergistic capacity contribution during charge and discharge from both Si and carbon nanotubes. A higher stability of silicon during cycling is provided due to bonding between the silicon coating and aligned carbon nanotube base material, and the outstanding elastic deformability of carbon nanotubes, which serve as a buffer layer for the silicon and compensates for the large volume expansion exhibited by Si when it is alloyed with lithium. Inside the Si-ACNT anode electrode, ACNTs offer many voids into which Si can expand without being in physical contact with the current collector, thus avoiding the problem of delamination that can occur with silicon electrodes in the absence of the carbon nanotubes. Delamination jeopardizes the integrity of the negative electrode, as has been observed in the case of Li_{4,4}Si. In addition, fast charge and discharge rates can be achieved because of the unique aligned structure of carbon nanotubes, their mesoporosity, and their relatively high electronic conductivity. A significant weight reduction and a longer lifetime are also provide by the composite materials of the invention as the result of integrating a high capacity anode within highly ordered aligned nanotube base material, which offers facile pathways for lithium ion insertion and de-insertion, as well as alloy formation between lithium and an alloying material such as Si. In particular, Si-ACNT provides a long-life negative electrode material with much improved energy and power densities for lithium ion batteries.

FIG. 2 schematically illustrates a nanotube having a coating of a lithium-alloying material on the interior and exterior surfaces thereof. Nanotube 101 (e.g., a carbon nanotube, conductive organic polymer nanotube, or inorganic nanotube), includes thin films 102, 103 of a lithium-alloying material (e.g., Si, Sn, Sb and Ge) on the interior and exterior surfaces, respectively, of nanotube 101.

FIG. 3. illustrates a similar embodiment to that shown in FIG. 2, except the lithium alloying material is present as particles 202, 203 on the interior and exterior surfaces, respectively, of nanotube 201.

### Selected Advantages of the Composite Materials of the Present Invention

The nanotube component of the composite materials of the present invention provides dimensional stability for lithium alloying materials such as silicon by serving as a buffer layer. Specifically, the nanotubes provide elastic deformability, which makes it possible to absorb the volume changes of the lithium alloying material when lithium is inserted therein and removed therefrom.

Nanotubes with an open-ended structure, such as certain open-ended aligned carbon nanotubes, possess a mesoporous structure, which provides fast access of electrolyte to electrode surface, and thus leading to fast charge and discharge rates.

Carbon nanotubes are a preferred aligned nanotubular base material in the present invention. Silicon, which possesses the highest known theoretical lithium ion charge capacity, is a preferred lithium-alloying material. The Si-aligned carbon nanotube (Si-ACNTs) composite materials of the invention provide a higher lithium ion capacity than traditional graphite materials or ACNT materials alone. In addition, the carbon nanotube component provides high electronic conductivity and helps improve the electrochemical performance of the lithium alloying material incorporated therein. Si-CNTs composite structure can be used as both an active material and a current collector, amplifying the weight savings associates with its high specific activity.

In addition, ACNT and Si-ACNT can be grown on the surface of a current collector (e.g., a Cu foil) and can be employed directly as working electrode without the need for binders and conductivity additives. ACNT growth and Si deposition can be carried out in the same reactor through sequential CVD processes, which further simplifies the fabrication process.

The following non-limiting examples are provided to further illustrate certain aspects and features of the present invention.

### EXAMPLE 1

### Synthesis of Carbon Nanotubes

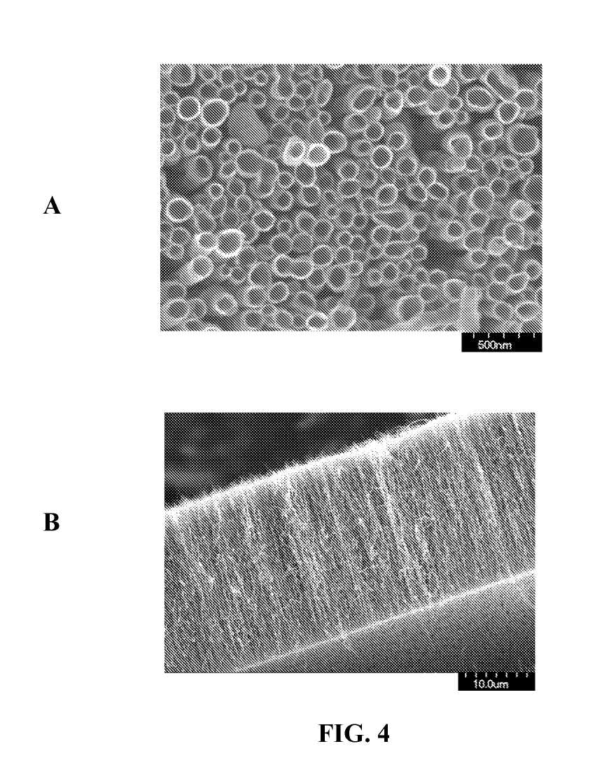

Carbon nanotubes (CNT) can be synthesized according to procedures that are known in the art. For example, carbon nanotubes were prepared by a chemical vapor deposition process inside a quartz tube inserted through a low-temperature heating section (Zone I, about 200° C.) and a high-temperature heating section (Zones II, about 750° C.). About 0.34 g of ferrocene was dissolved in about 22.63 mL of xylene and used as the precursor for the CNT synthesis. The solution was injected into and vaporized in Zone I. A hydrogen and argon mixture (60 mL/min and 90 mL/min, respectively) was used to transport the vaporized ferrocene and xylene mixture from Zone Ito Zone II. The CNTs were formed over a polished quartz plate inside Zone II. After about 30 minutes, the solution injection was stopped and the furnaces heating Zones I and II were cooled down to room temperature with the argon and hydrogen gas mixture still flowing. FIG. 4 shows SEM images of a typical ACNT material useful in the composites of the present invention. Panel A of FIG. 4 shows a view along the alignment axis of the nanotubes, while Panel B shows a side view.

### EXAMPLE 2

### Conducting Polymer Nanotubes

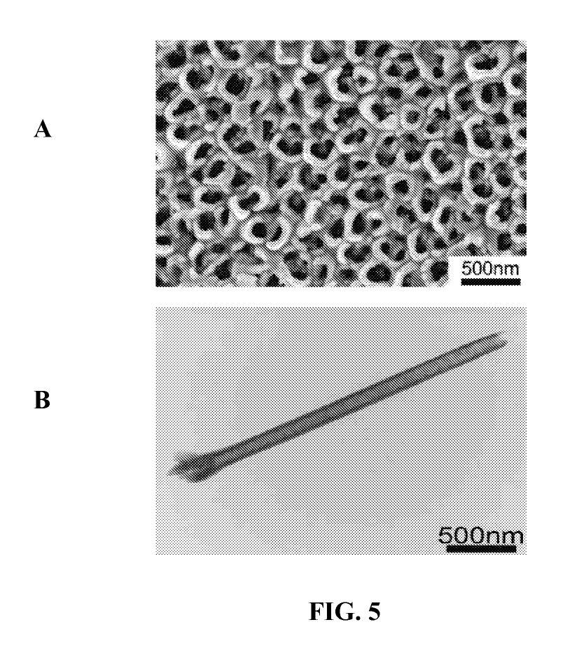

Conductive polymer nanotubes have been fabricated by various methods known in the art. Such methods can be divided into at least three categories: template (or hard template) methods, pseudotemplate (or soft template) methods, and template-free methods. Template methods have been widely used because of their simplicity, versatility, and controllability. The hard template is usually a thin porous film of aluminum oxide or polycarbonate. Different kinds of conducting polymers have been deposited in the cylindrical pores of such films to form nanotubes or nanowires. The deposition has been performed by methods such as pressure injection, vapor deposition, chemical deposition, and electrodeposition; the last two of these methods being the most popular in recent research. For purposes of illustration, FIG. 5 provides SEM and TEM images of poly(3,4-ethylenedioxythiophene) nanotube material (from Cho, S. I. and Lee, S. B., 2008. “Fast Electrochemistry of Conductive Polymer Nanotubes: Synthesis, Mechanism, and Application”, Accounts of Chemical Research, 41 (6): 699-707) which is suitable for use in the present invention. Panel A of FIG. 5 shows a view along the alignment axis of the nanotubes, while Panel B shows a TEM side view of one of the nanotubes.

### EXAMPLE 3

### Surface Modification of Aligned Carbon Nanotubes

The as-synthesized ACNTs were steam oxidized to introduce a surface functional group in order to deposit a Pt catalyst on the surface. This steam oxidation was achieved in the same CVD reactor as was used to synthesize the ACNT according to Example 1, using the following procedure: Zone I and Zone II were heated and kept at about 500° C. and about 800° C., respectively. Deionized water was injected into the quartz tube at the middle sites of Zone I at the rate of about 0.225 mL/min to generate steam. Flowing argon (about 140 mL/min) was used to carry the steam to Zone II and react with ACNTs that were synthesized in the reactor using the CVD process described in Example 1. The water injection was continued for about 50 minutes, after which time the heating was terminated and the contents of the reactor were cooled to room temperature with flowing argon.

### EXAMPLE 4

### Deposition of Silicon on Carbon Nanotubes

Following the formation of the carbon nanotubes, a film of nanoscale silicon particles is deposited at the surface of the nanotubes. This deposition may be carried out, for example, by chemical vapor deposition (CVD) starting from silylated precursors, such as the silane (SiH₄), which makes it possible to obtain a uniform distribution of the silicon, which thus forms a sheath around each nanotube. For example, the gaseous silyl precursors, such as silanes (e.g., SiH₄), can be deposited on carbon nanotubes, which are pre-heated at about 600° C. to give a uniform coating of silicon on carbon nanotubes according to a reaction such as the following:

SiH₄ (gas)→Si (solid)+H₂ (gas).

Alternatively, another gaseous silicon precursor material, such as trichlorosilane can be used in place of silane.

In a specific example, ACNTs were prepared through a one-step, chemical vapor deposition (CVD) process using inexpensive aromatic hydrocarbons and transition metal compounds. Briefly, a liquid mixture of xylene and Ferrocene was injected into the low-temperature zone of a CVD reactor and was fully vaporized. The vapor mixture was carried downstream to the high temperature zone by hydrogen and inert gas and was subsequently decomposed over a copper foil substrate.

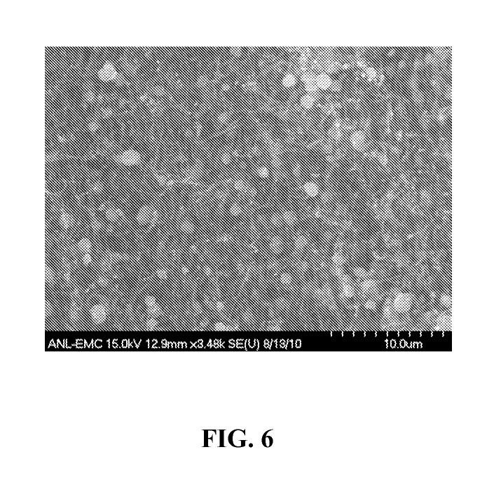

For CVD of silicon deposition, the same reactor as ACNT synthesis was used. Briefly, liquid trichlorosilane (TCS) was injected into the low-temperature zone (100° C.) of the reactor and was fully vaporized. The vapor mixture was carried downstream to the high temperature zone by hydrogen and was subsequently decomposed over the ACNT material, which was preheated to 800° C. At this temperature, TCS decomposed to finely dispersed, equally sized silicon nanoparticles outside and inside the graphene layers of the ACTNs. FIG. 6 show the SEM image of Si-ACNTs supported on copper foil, which is the current collect normally used in lithium ion batteries. The ACNTs typically have diameters in the range of 2 to 50 nm and length in the range of 5 to 50 μm, which fall in the typical thickness of a battery electrode. The silicon nanoparticles are uniformly dispersed inside the ACNT bundles.

The as prepared Si-ACNT material supported on copper foil was used directly as the anode for a lithium ion battery. The performance was evaluated in a 2032-type coin cells. The cell was configured with lithium foil as negative electrode, a 25 μm Microporous Trilayer Membrane (Celgard 2325) as separator, the above prepared electrode as positive electrode, and an appropriate amount of electrolyte. The electrolyte was 10 wt % of fluoroethylene carbonate (FEC) combined with 1.2M LiPF₆ dissolved in the mixture solvent of ethylene carbonate (EC) and ethyl methyl carbonate (EMC) with an EC:EMC volume ratio of about 3:7. The electrochemical performance of the Si-ACNT composite material was investigated by cycling the cell between 0.02 to 1.5 V with a constant current of different rates using a computerized battery test system manufactured by Maccor, Inc.

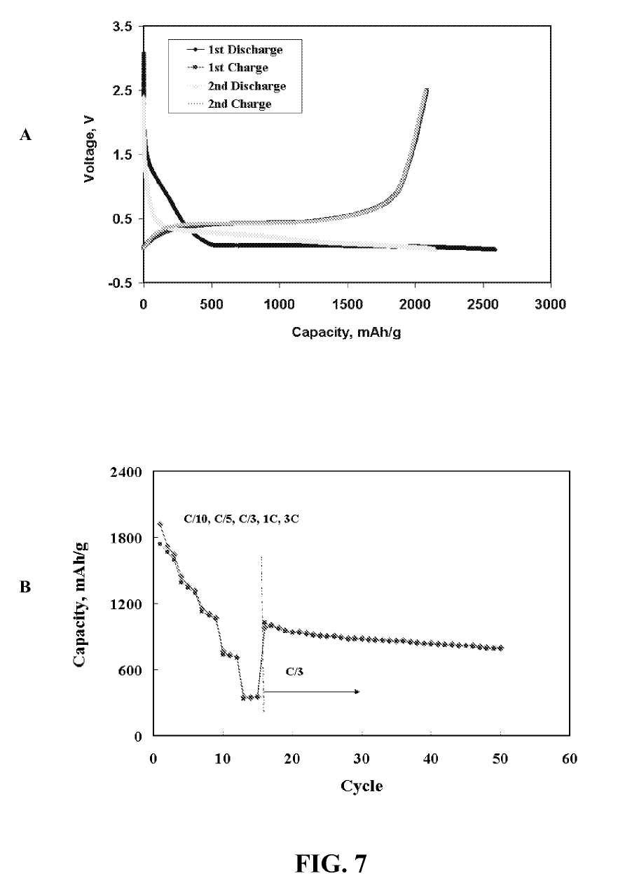

FIG. 7 shows the cycling performance of this Si-ACNT material. The first cycle efficiency is about 80%, which is mainly due to the reaction of electrolyte with carbon/silicon surfaces to form solid-electrolyte-interface (SEI) layer. A plot of Voltage versus Capacity is shown in Panel A, and a plot of Capacity versus Cycle number is shown in Panel B. The reversible capacity of this Si coated CNT is determined to be over 840 mAh/g after 50 cycles at room temperature. For comparison, silicon powder (˜10 μm average diameter) lost over 90% of its capacity after 10 cycles, as reported in the literature [Ryu et al., Electrochemical and Solid-State Letters, 2004; 7:A306]. In the Si-ACNT material, the ACNTs served as support materials and buffer layer for silicon, therefore, Si can expand without being in physical contact with the current collector where a problem of delamination usually occurs—a process that would jeopardize the integrity of the negative electrode. Higher stability of silicon during cycling is achieved due to the outstanding elastic deformability of carbon nanotubes, which accommodate the tensions caused by the huge silicon volume change. The results demonstrate that CNTs stabilized silicon during repeated alloying and de-alloying processes and possessed over 2 times the reversible capacity of state-of-the-art graphite materials. This is the first demonstration of synthesizing aligned carbon nanotubes on copper foil and followed by in-situ CVD deposition of silicon of which the inventors are aware.

This Example demonstrates the following benefits: (1) ACNT and Si-ACNT can be grown on the surface of a current collector (e.g. Cu foil) and can be employed directly as working electrode without the need for binders and conductive additives; (2) ACNT growth and Si deposition will be carried out in the same reactor through sequential CVD processes, which simplify the fabrication process; (3) a Si-ACNT hybrid structure can be used as both an active material and a current collector, amplifying the weight savings associated with its high specific capacity, and (4) higher stability of silicon during cycling is achieved due to the outstanding elastic deformability of carbon nanotubes.

### EXAMPLE 5

### Si-ACNT Composite Prepared Through Magnetron Sputtering Method and its Battery Performance

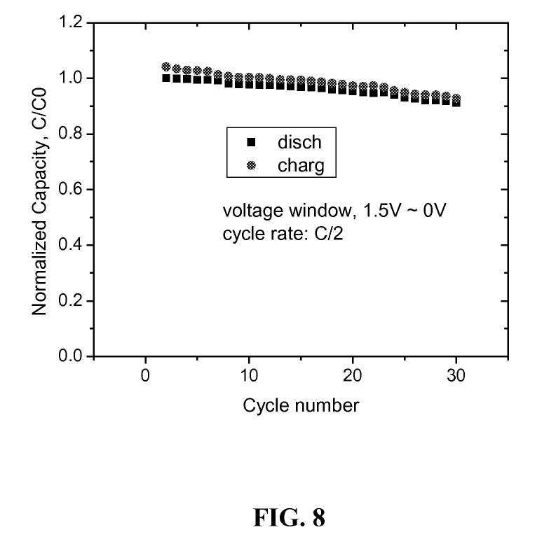

A thin layer of silicon was deposited onto ACNTs prepared as in Example 1 using magnetron sputtering, and the capacity resulting composite in a half cell configuration was tested. The reversible capacity of this Si-coated ACNT composite was determined to be over 750 mAh/g. FIG. 8 shows the cycling performance of this Si-ACNT material. Surprisingly, over 90% capacity retention was observed after 30 cycles at room temperature. For comparison, silicon powder (about 10 μm average diameter) lost over 90% of its capacity after 10 cycles, as reported by Ryu Ji Heon et al., “Failure Modes of Silicon Powder Negative Electrode in Lithium Secondary Batteries,” Electrochemical and Solid-State Letters 2004; 7 (10): A306-A309. The present result demonstrates that the silicon-coated ACNTs surprisingly stabilized the silicon during repeated alloying and de-alloying processes, and exhibited almost 2 times the reversible capacity of state-of-the art graphite materials.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. A composite material suitable for use in an anode for a lithium ion battery, the composite material comprising a layer of a lithium-alloying material on the wall surfaces of an aligned nanotubular base material.

2. The composite material of claim 1 wherein the lithium-alloying material comprises a material selected from the group consisting of Si, Sn, Pb, Al, Au, Pt, Zn, Cd, Ag, Mg, and a combination of two or more of the foregoing.

3. The composite material of claim 1 wherein the lithium-alloying material comprises silicon.

4. The composite material of claim 1 wherein the aligned nanotubular base material comprises a material selected from the group consisting of a conductive organic polymer, a conductive or semiconductive inorganic material, or a combination thereof.

5. The composite material of claim 1 wherein the aligned nanotubular base material comprises at lease one material selected from the group consisting of polyaniline, polypyrrole, and polythiophene.

6. The composite material of claim 1 wherein the aligned nanotubular base material comprises at least one material selected from the group consisting of a metal (e.g., Ni, Ag, Cu, Te, Co, Fe, Bi), a chalcogenide (e.g., MoS₂, WS₂, MoSe₂, WSe₂, NbS₂, NbSe₂, HfS₂, ZrS₂, TiS₂, TiS₂, TiSe₂), an oxide (e.g., TiO₂, H₂Ti₃O₇, ZrO₂, VOₓ, SiO₂, IrO₂, ZnO, Ga₂O₃, BaTiO₃, PbTiO₃, K₄Nb₆O₁₇), a nitride (e.g., BN, AIN, GaN), a phosphide (e.g., InP), a halide (e.g. NiCl₂), and carbon.

7. The composite material of claim 1 wherein the aligned nanotubular base material comprises aligned carbon nanotubes (ACNT).

8. The composite material of claim 1 wherein the aligned nanotubular base material comprises nanotubes having diameters of not more than about 100 nm.

9. The composite material of claim 1 wherein the aligned nanotubular base material comprises nanotubes having diameters in the range of about 2 to about 100 nm.

10. The composite material of claim 1 wherein the aligned nanotubular base material comprises nanotubes having an average spacing between any two adjacent nanotubes in the range of about 5 to about 300 nm.

11. The composite material of claim 1 wherein the aligned nanotubular base material comprises a open-ended nanotubes, close-ended nanotubes, or both.

12. The composite material of claim 1 wherein the lithium-alloying material is present on the surface of the aligned nanotubular base material in a layer having an average thickness in the range of about 1 to about 200 nm.

13. The composite material of claim 1 wherein the layer of lithium-alloying material on the surface of the aligned nanotubular base material comprises a film.

14. The composite material of claim 1 wherein the layer of lithium-alloying material on the surface of the aligned nanotubular base material comprises particles of the lithium-alloying material.

15. The composite material of claim 1 wherein lithium-alloying material is present on the exterior tubular surfaces of the aligned nanotubular base material.

16. The composite material of claim 1 wherein lithium-alloying material is present on the interior tubular surfaces of the aligned nanotubular base material.

17. The composite material of claim 1 wherein the aligned nanotubular material comprises single-walled carbon nanotubes, multi-walled carbon nanotubes, or both.

18. An electrochemical cell comprising an cathode, an anode, and a lithium ion-containing electrolyte therebetween, wherein the anode comprises the composite material of claim 1.

19. The electrochemical cell of claim 18 wherein the cathode comprises one or more material selected from a lithium metal oxide, a phosphate, and a spinel.

20. The electrochemical cell of claim 18 wherein the lithium ion-containing electrolyte comprises a lithium salt in an organic solvent.

21. A battery comprising a plurality of the electrochemical cells of claim 1 arranged in series, parallel, or both.
